(19) United States
(12) Patent Application Publication
(10) Pub. No.: US 2026/0145459 A1
(43) Pub. Date: May 28, 2026

(54) Artistic Embedding of Spherical Objects in Epoxy Resin for Decorative and Functional Displays

(71) Applicants: Jake Chen, Irvine, CA (US); Olivia Chen, Irvine, CA (US)

(72) Inventors: Jake Chen, Irvine, CA (US); Olivia Chen, Irvine, CA (US)

(21) Appl. No.: 18/957,731

(22) Filed: Nov. 23, 2024

(51) Int. Cl. B44C 5/00

(52) U.S. Cl. CPC B44C 5/00

(57) ABSTRACT

A method for creating spherical object-based epoxy artwork using golf balls, ping pong balls, or similar spherical items arranged into a predetermined design. The objects are adhered to a surface and encapsulated in epoxy resin, which may include mixed media elements such as diamond dust, glitter, dried flowers, fabric, foil, branding components, or symbolic items. Once cured, the resin forms a durable, glossy, and rigid structure that preserves both texture and visibility. The final product may be mounted or framed for display purposes.

### BACKGROUND OF THE INVENTION

Traditional epoxy resin artwork often incorporates flat or irregular objects to create a visually striking piece. However, such methods lack the ability to fully integrate spherical objects, such as golf balls or ping-pong balls, into customizable designs while maintaining structural integrity and aesthetic appeal.

The current methods often fail to combine the transparency and durability of epoxy with the three-dimensionality of spherical objects, limiting the scope of applications for luxury art or functional decor. This invention addresses these limitations by introducing a novel process for embedding small round objects in epoxy resin, providing a durable, visually appealing solution that can be customized for a wide range of artistic and commercial purposes.

### SUMMARY OF THE INVENTION

This invention provides a method for creating customizable artwork by embedding small round objects in epoxy resin. The objects are arranged in a predetermined pattern, such as a grid or freeform design, on a flat surface or mold. Layers of epoxy resin are then poured over the arrangement, encapsulating the objects while maintaining transparency and depth. The final product is cured and polished to a high-gloss finish, resulting in a visually striking piece that is both durable and versatile. Optional enhancements, such as metallic finishes, crystals, or LED lighting, can be added to elevate the artistic appeal. This method is suitable for creating high-end decor, gallery artwork, or functional display pieces.

### DETAILED DESCRIPTION OF THE INVENTION

### 1. Materials

Epoxy Resin: A two-part resin system (resin and hardener) that cures into a transparent, glass-like finish.
Small Round Objects: Golf balls, ping-pong balls, or similar spherical items.
Mold or Base: A flat surface, tray, or frame to hold the objects and epoxy during the curing process.
Optional Enhancements:
   Metallic paints or reflective coatings for the objects.
   LED lighting integrated into the base or frame.
   Decorative crystals or embellishments.

### 2. Process

### Step 1: Object Preparation

Clean and prepare the small round objects to ensure they adhere to the epoxy resin. Optionally, apply metallic paint or custom finishes for additional aesthetic appeal.

### Step 2: Arrangement

Arrange the objects in a pre-designed layout on the mold or base. Patterns can include grids, concentric circles, or freeform designs, depending on the artistic vision.

### Step 3: Epoxy Resin Preparation

Mix the resin and hardener according to the manufacturer's instructions, ensuring a bubble-free mixture for maximum clarity.

### Step 4: Embedding Process

Pour the first layer of epoxy resin into the mold or over the arranged objects, covering their base. Allow this layer to cure partially.
Gradually pour additional layers of resin until the objects are fully encapsulated. Let each layer cure to prevent displacement of the objects.

### Step 5: Curing

Allow the entire piece to cure for 24-72 hours, depending on the resin's curing time and environmental conditions.

### Step 6: Polishing and Finishing

Sand and polish the cured resin to achieve a smooth, high-gloss finish. Additional decorative elements, such as LED lighting or framing, can be added at this stage.

### 3. Applications

Home Decor: Modern wall hangings or tabletop pieces.
Gallery Artwork: High-end, visually striking exhibits.
Sports Memorabilia: Custom designs using sports equipment (e.g., golf balls) for collectors.

### EXAMPLES

1. Grid Pattern: Golf balls are arranged in a 10×15 grid, covered with clear epoxy, and framed with metallic accents for a gallery-ready piece.
2. Freeform Design: Ping-pong balls are painted with reflective finishes and arranged in a flowing, abstract pattern within a resin frame.
3. Integrated Lighting: A 3D display with embedded LED lights beneath the epoxy for a glowing, futuristic effect.

1. A method of creating golf ball epoxy artwork, comprising: arranging a plurality of spherical objects, including golf balls, ping pong balls, or similar items, into a predetermined design; securing the spherical objects onto a substrate; applying an epoxy resin to encapsulate and permanently bond the objects to form the artwork; and allowing the epoxy resin to cure to produce a durable, rigid, glossy, and displayable piece of art, wherein the epoxy resin may be colored with pigments to enhance visual appeal.
A. The method of claim 1, further comprising incorporating mixed media, including but not limited to diamond dust, glitter, dried flowers, fabric, paint, foil, natural materials, synthetic objects, paper, branding elements, or other decorative or symbolic items, into or onto the epoxy layer or the spherical objects themselves.
B. The method of claim 1, wherein the substrate provides a display-ready format including an optional frame, mounting mechanism, or backing support.
